(19) United States
(12) Patent Application Publication
(10) Pub. No.: US 2012/0317148 A1
(43) Pub. Date: Dec. 13, 2012

(54) SYSTEM AND METHOD TO REPRESENT THE GENEALOGY OF PHYSICAL AND ABSTRACT OBJECTS

(75) Inventors: LEONARD R. KOENIG, Jobstown, NJ (US); DAVID A. STACHELCZYK, Nazareth, PA (US)

(73) Assignee: EXXONMOBIL RESEARCH AND ENGINEERING COMPANY, Annandale, NJ (US)

(21) Appl. No.: 13/487,444

(22) Filed: Jun. 4, 2012

Related U.S. Application Data
(60) Provisional application No. 61/494,506, filed on Jun. 8, 2011.

(51) Int. Cl. G06F 17/30

(52) U.S. Cl. 707/797; 707/791; 707/E17.012

(57) ABSTRACT

The present invention relates to systems and methods for representing interrelated data objects in a database as a hierarchical rooted tree, and also involves a computer program for visualizing, creating, and modifying such trees.

### CROSS-REFERENCE TO RELATED APPLICATIONS

This application claims priority to U.S. Ser. No. 61/494,506, filed Jun. 8, 2011, herein incorporated by reference in its entirety.

### BACKGROUND OF THE INVENTION

The present invention relates to a system and method for unambiguously describing the relationship of interrelated objects in a database. The method can advantageously utilize an efficient data structure describing a collection of directional line segments to relate the objects and describe how they are related. The present invention also relates to a computer program for facilitating interpretation and graphical construction of those relationships.

### SUMMARY OF THE INVENTION

The present invention includes a system and a method for representing the genealogy of interrelated data objects in a database via a directed acyclic graph representing a hierarchical rooted tree. These relationships can advantageously be stored in an efficient data structure within a database. The nodes on the graph represent the data objects, and the directed line segments represent the relationship of those data objects to each other. A set of core constraints assert the integrity of the graph. Additional constraints can be applied, via the software, to enforce domain or workflow specific business rules. A computer program, which interprets these rules, can then be used to construct, display, edit, update, and/or interact with the graphs. FIG. 1 shows a flowchart summarizing the logic for rendering graph representation of the genealogy tree of the present invention.

In practical applications, representing the hierarchical rooted trees of a material, which may be the result of several complex chemical transformations and blending (which may include one or more of its own ancestors), can provide a unique opportunity for interpreting the effects of chemical transformations to the material's antecedents.

### BRIEF DESCRIPTION OF THE DRAWINGS

FIG. 1 shows a flowchart for the present invention for the representation of a genealogy tree.

FIGS. 2A and 2B collectively show a flowchart for creating a genealogy tree of the present invention.

FIG. 3 shows genealogy trees for example 1.

FIG. 4 shows the related genealogy trees for example 1.

FIG. 5 shows the genealogy tree of example 2.

FIG. 6 shows the genealogy tree of example 3, and use of the computer program to visualize performance data for the materials represented by nodes in the hierarchical rooted tree.

### DETAILED DESCRIPTION OF THE EMBODIMENTS

The present invention includes a system and method to create and manage the relationship or genealogy of interrelated data objects in a database. The present invention can include the following: a data base including an efficient data structure for representing these relationships of the members of the data base via collections of connectivity descriptors; a set of core constraints or rules to ensure the integrity of these relationships; a set of workflow or domain specific business rules for further defining how these relationships are enforced; and a computer program for displaying, creating, editing, updating, and/or visually interacting with these relationships.

### 1. Genealogy Data Structure

The arbitrary relationship or connectivity between specific data objects in a database can be difficult to represent and visualize using existing informatics techniques. The invention, herein described, thus advantageously can use an efficient data representation of a hierarchical rooted tree. These trees can be comprised of nodes representing the data objects, and directed line segments or transitions representing the relationship between the nodes. A node is said to have an inbound transition if there is a directed line segment that terminates at this node. Likewise, a node is said to have an outbound transition if a directed line segment originates at this node. Nodes are separated into two types: root being the object whose genealogy is being represented, and ancestors from whom the root is derived. Within ancestor nodes, those with no inbound transitions are considered leaves, and are used to represent the farthermost objects in the tree from the root. The underlying data structure of the connectivity descriptors can resemble directional line segments, containing a starting and an ending node object, as well as a transformation object that can describe how the starting and ending nodes relate to each other. Some additional information can be carried along to enrich the visual representation of the tree and/or to aid in the programmatic traversal of the tree, but the directional line segments described above should generally be sufficient to describe the connectivity of any hierarchical rooted tree. This collection of connectivity descriptors provides a definition of the network representing the genealogy of objects, as well a means for its visualization.

### 2. Core and Workflow-Specific Constraints

Constraints can be asserted, advantageously prior to storing trees to the database, and in some cases during their visual rendering. Those constraints can include the following: 1) A given node can only show up once in the rendered graph, and, if it is already present, the transitions between nodes can simply be rendered. Thus, the interrelations between trees containing common nodes can be represented, as well as a node's presence as an ancestor via multiple paths. 2) The only transitions that can terminate at a common end node can typically be dictated by workflow or domain specific rules. 3) Root nodes can only have inbound transitions. 4) A valid genealogy consists of only those paths containing the direct ancestors between the root and the leaf nodes. 5) Within a given path of a tree, no node can have an outbound transition to one of its ancestors. 6) A transition cannot originate and terminate on the same node.

### 3. Interactive Visualization of Genealogy

Included in the software framework can be a computer program for displaying, creating, updating, and/or visually interacting with genealogies. The computer program can be composed both of an interactive utility used to graphically construct and to display genealogies in the form of a hierarchical rooted tree, and of a programmatic interface which can be called to create the underlying data representation. The interactive computer program can be an event driven application. The actual drawing of the nodes and transitions that connect nodes can be managed by a variety of custom controls. These drawing controls are not typically considered novel, and their specifics will not be herein described.

The interactive computer program can respond to various asynchronous menu choices, button clicks, and/or mouse actions, so describing its complete logic in the form of a flowchart can be meaningless. However, examples of the summarized logic for rendering a graph representing a genealogy tree (considered to be a facet of the invention), and creating a genealogy using the programmatic interface, which has a single entry and exit point, are shown in the attached Figures.

The arguments to the programmatic interface can include the name of the workflow whose business rules will be imposed, and a collection of connectivity descriptors or transitions. The logic of the programmatic interface can be separated into four basic steps: 1) Creating new trees and/or expanding existing trees to include trees that may already exist for ancestor nodes; 2) Applying core constraints to the tree, thus ensuring that the workflow specific business rules are being enforced; 3) Storing the underlying collection of connectivity descriptors for a given data object to the database; and 4) Visually interacting with the genealogy tree to access additional information associated with its constituent nodes and/or transitions. For example, characterization results of the material and all of its ancestors can be viewed by interacting with the diagram representing the material's genealogy. The data representing the genealogy can be stored in a database in context to the synthesis data describing the material. Genealogy data stored in the database can allow researchers the opportunity to easily search for materials with specified ancestors, ancestor's performance, and/or those subjected to specific transitions.

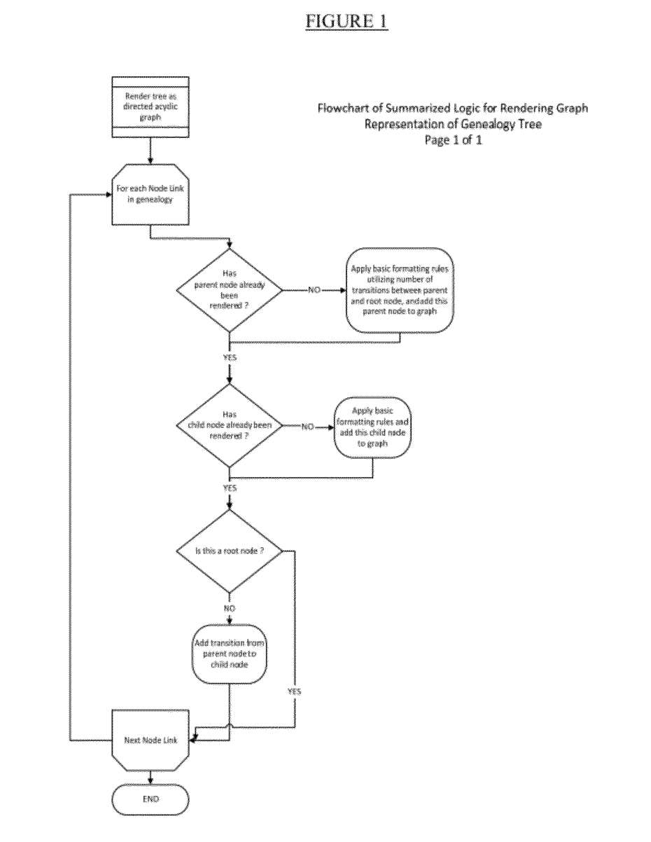

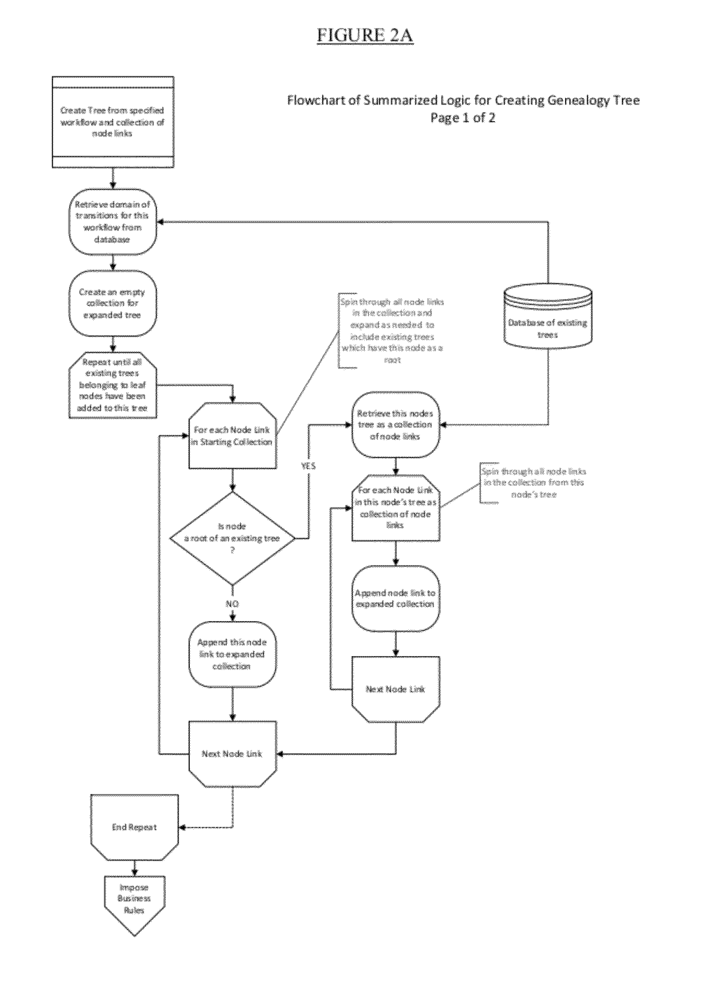

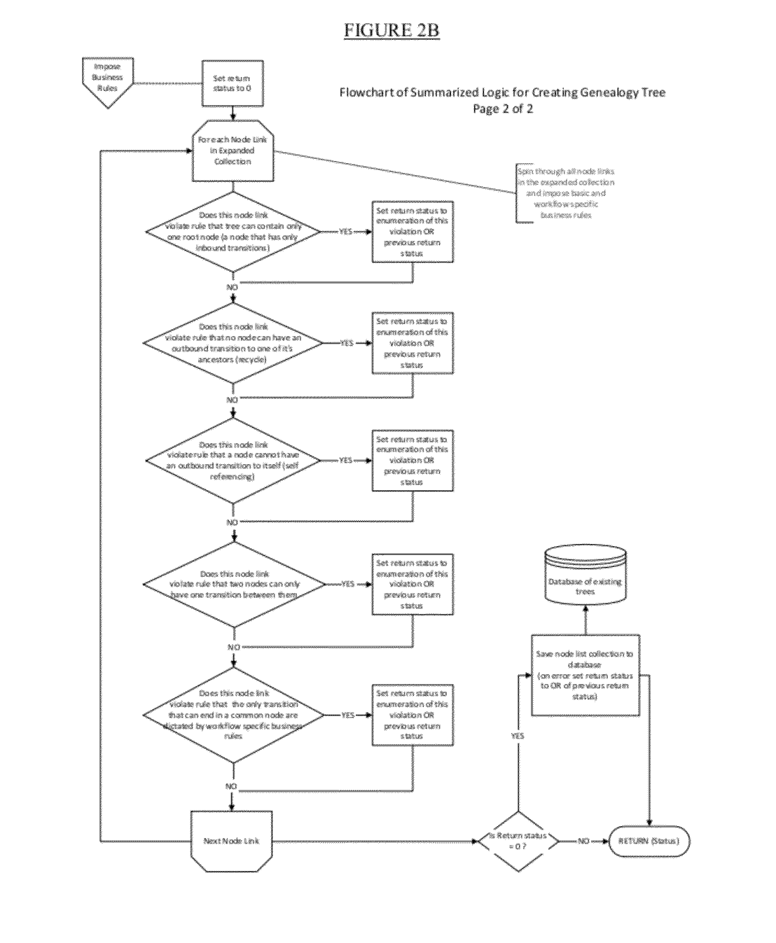

The programmatic interface logic for rendering, expanding, and validating hierarchical rooted trees is shown in FIGS. 1, 2A, and 2B.

### EXAMPLE 1

### Illustration of Method

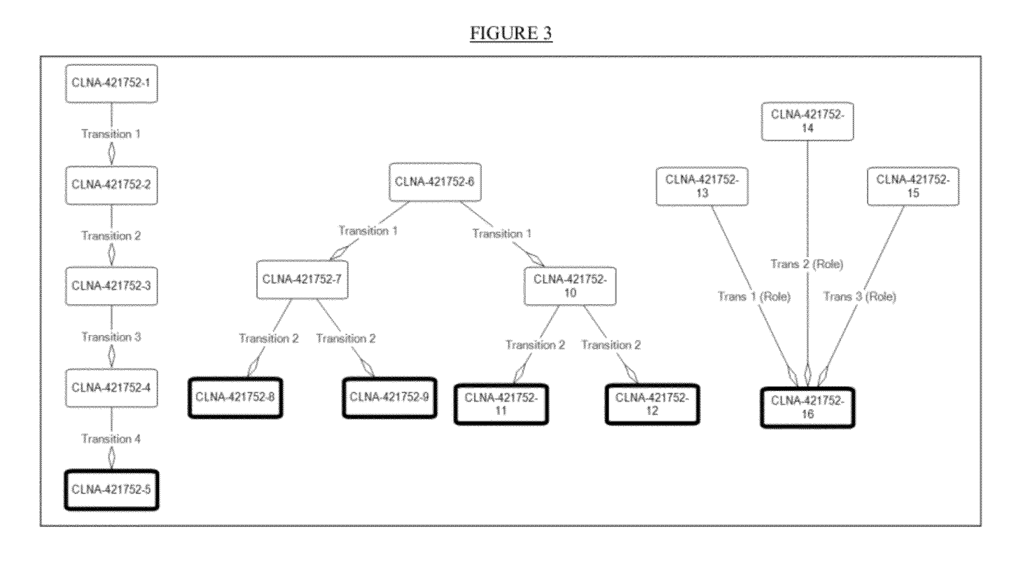

FIG. 3 depicts several root nodes. The leftmost tree depicts a multi-step transition which may, for instance, represent heterogeneous catalyst synthesis, where physical materials can be transformed via some chemical/physical means to create new materials, which in turn can be transformed via some chemical/physical means to create new materials. The center collection of trees depicts a separation of objects, all derived from a common starting node, which may, for instance, represent a physical/chemical separation. The rightmost tree depicts a root with three direct ancestors, which may, for example, represent a blend/mixture or the aggregation of abstract contributions from multiple sources, and the role of each of those sources in the aggregation.

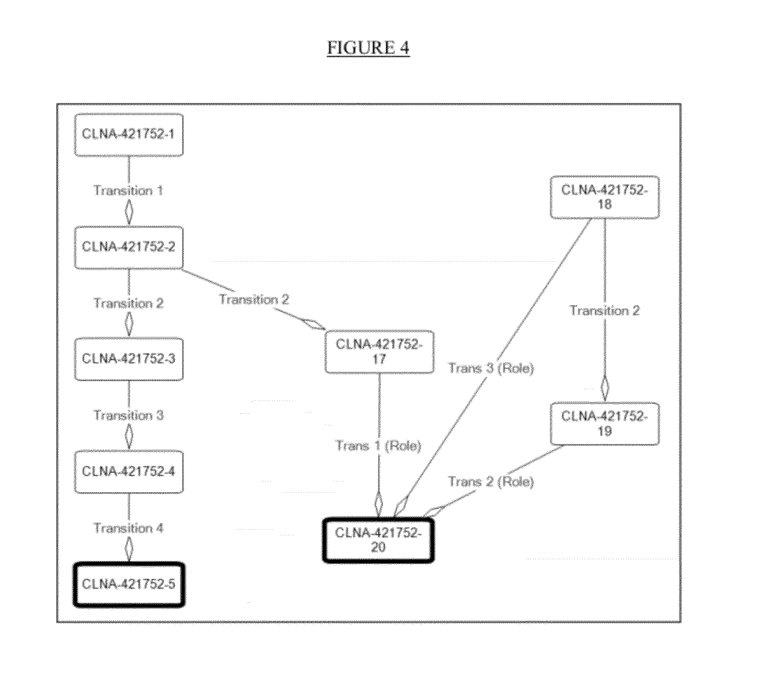

FIG. 3 illustrates the rules given above, namely, nodes can only show up once on the graph, and, if they already present, the transitions between nodes are simply rendered. As seen in FIG. 4, the interrelations between trees can be represented, such as the sharing of node CLNA-421752-2 between the two trees, as well as node CLNA-421752-18's presence as an ancestor that is both 1, and 2 transitions away from the root. The only transitions that can end in a common end node are dictated by domain specific rules. Root nodes can only have inbound transformations. The genealogy consists of only hierarchical rooted trees of direct ancestors between the root and the leaf nodes. Within a tree, no node can have an outbound transition path to one of its ancestors. Nodes cannot be both the starting and ending nodes of a specific transition.

### EXAMPLE 2

### Oil Life in Family Car

Suppose one wanted to understand how automotive engine oil degraded with accumulated mileage, and when it should optimally be changed. One might sample some of the oil every time the oil was checked, and top off the level with fresh oil. The accumulation of mileage on the oil, and the blending of used with fresh oil illustrates the technique by describing the used oil as the result of a transition of the fresh oil, and subsequent generations being blends of fresh and transformed blends of used oil.

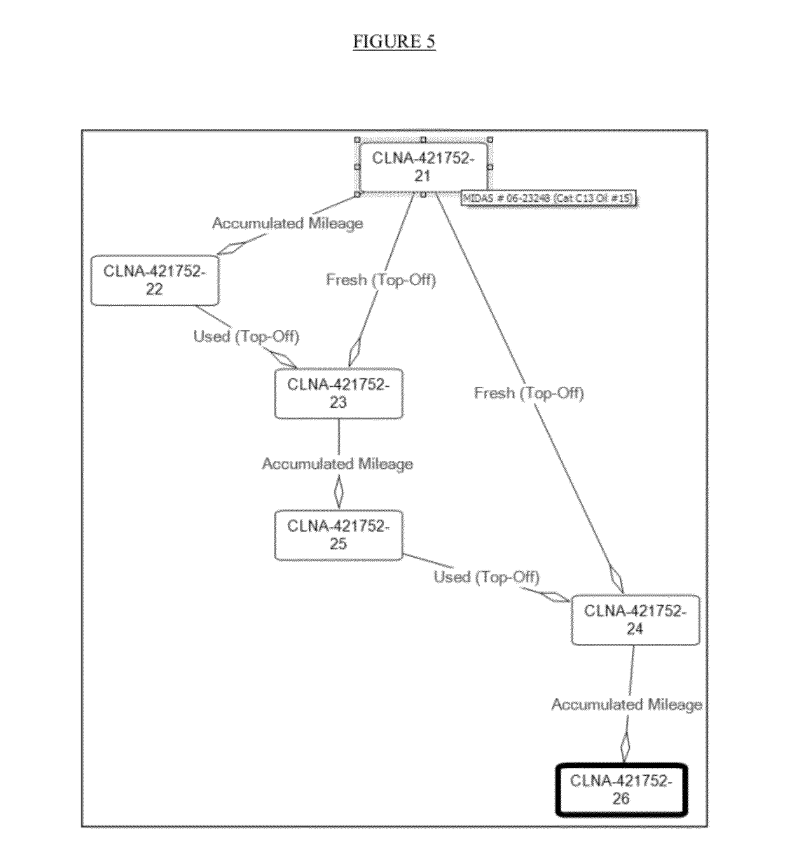

For example, a case of oil with the designation of CLNA-421752-21 was bought, and an oil change was performed on one's car. Multiple tests could be performed on the fresh oil to get a base line, and perhaps some condemning limit is known to signal when the oil needs to be changed. With checking the oil only three times, one could generate a genealogy network for the content of one's crankcase, e.g., as illustrated in FIG. 5.

### EXAMPLE 3

### Catalyst Activity

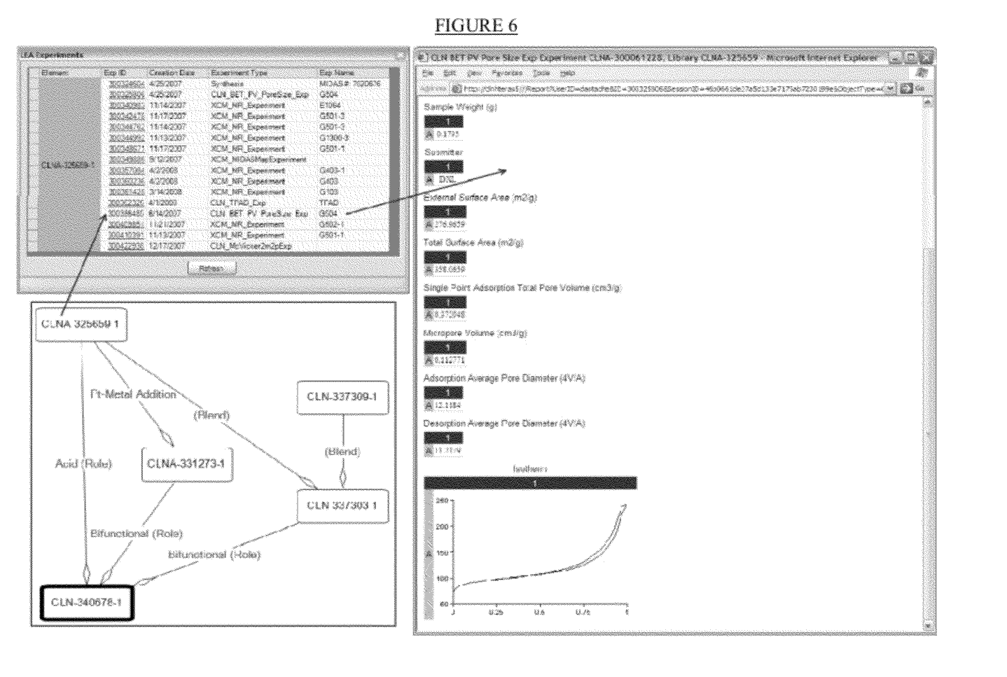

In order to characterize the intrinsic performance of catalysts, for instance, a variety of performance measurements can be conducted on various forms of the catalyst. It is important to understand and document in a database the role that a particular form of catalyst can contribute to the overall performance profile. The hierarchical rooted tree illustrated in FIG. 6, for example, demonstrates the computer program's interactive visualization of the underlying data objects in a database. The rendering of the tree can show the transitions applied to a common starting material, the linking of those materials to data objects required for certain types of testing, and roles those materials contribute, for example. Additionally, users can interact with the rendered tree to display performance details of the materials represented by nodes in the tree.

What is claimed is:

1. A method to represent the genealogy of data objects in a database as hierarchical rooted trees on a graph comprising:
a. root nodes whose genealogy is being represented;
b. ancestor nodes from who the root is being derived; and
c. connectivity descriptors which connect nodes to each other and identify transitions of one node to another node.

2. The method of claim 1 wherein root nodes and ancestor nodes can appear only once on a graph.

3. The method of claim 1 wherein root nodes can have only inbound connectivity descriptors.

4. The method of claim 1 wherein ancestor nodes absent inbound connectivity descriptors are leaf nodes.

5. The method of claim 1 wherein different family trees are combined to form a forest.

6. The method of claim 1 wherein said connectivity descriptors are stored as data objects in a database.

7. The method of claim 1 further comprising a computer program to interpret the data objects stored in a database as a hierarchical rooted tree comprising:
a. visualization of the tree;
b. creation, editing, and storage of the tree; and
c. interaction with nodes and transitions of the tree or forest.

8. A computer readable system for representing the genealogy of interrelated data objects comprising:
a. a database, including a data structure for representing the genealogy of the interrelated data objects which are represented as nodes wherein relationships between the nodes are represented by connectivity descriptors, a set of core constraints and specific business rules; and
b. a computer program for displaying, creating, editing, updating, and visually interacting with these relationships.
